(19) United States
(12) Patent Application Publication
(10) Pub. No.: US 2007/0044324 A1
(43) Pub. Date: Mar. 1, 2007

(54) Power Tool Attachments

(76) Inventor: Arthur Harris, New York, NY (US)

Correspondence Address: JACKIE JAY SCHWARTZ, 1350 Broadway, Suite 1510, NEW YORK, NY, 10018, US

(21) Appl. No.: 11/466,960

(22) Filed: Aug. 24, 2006

Related U.S. Application Data
(60) Provisional application No. 60/596,081, filed on Aug. 30, 2005.

(51) Int. Cl. B27B 9/04

(52) U.S. Cl. 30/374

(57) ABSTRACT

An insert for use with a portable power tool. The insert includes a working section having at least one active site positioned on a surface thereof and a connection section connected to the working section including an adapter able to be selectively received by the portable power tool. An adjustable skid plate is provided for selectively adjusting an angle at which the insert impacts a work surface.

### CROSS-REFERENCE TO RELATED APPLICATIONS

This is a Non-provisional Application which claims priority from the Provisional Application Ser. No. 60/596,081 filed on Aug. 30, 2005 by Arthur Harris.

### FIELD OF THE INVENTION

The present invention relates to attachments for power tools and, more specifically, to blades for use with a saw and a device for controlling cutting blade depth of the saw.

### BACKGROUND OF THE INVENTION

The conventional method of preparing surfaces for at least one of painting and finishing is performed by manual labor whereby a user with a handheld file and/or rasp moves the file or rasp over the desired surface area. Additionally, a hammer and chisel may also be used to aid in preparing a surface for painting or finishing. These surfaces include at least one of wood and metal. Preparation of wood conventionally requires the use of a combination of sanders, planes, files and rasps. In contrast, to adequately prepare a metal surface, a hammer and chisel may be required to chip away at the material currently coating the metal surface. Thereafter, a file and or rasp must be employed to smooth down the surface such that a new coating of paint or finish can be applied thereto. Heretofore, these activities require arduous manual labor by skilled workers.

Additionally, these handled tools are not able to be connected to a power tool, such as a saber saw. Rather, these tools are only able to be held by a user an manipulated by that user. They are not able to be automated using their present construction.

Therefore a need exists to produce at least one of a file, rasp and chisel with a connector able to be received by an input port on a power tool. A further desire exists to automate the process and reduce the amount of time to complete the preparation process while maintaining a high level of surface integrity such that, upon completion, the surface is able to be at least one of painted or finished with a high degree of reliability.

While these devices may be suitable for the purposes for which they were designed, they would not be suitable for the purposes of the present invention, as hereinafter described.

### SUMMARY OF THE INVENTION

An insert for performing a desired action on a selected surface. The insert includes a main body and a connector for receipt by a power tool. At least one surface of the insert is an active edge for performing the desired action on the selected surface. Upon contacting the surface with the active edge and activating the power tool, the insert is caused to move in a reciprocating manner and automatically perform the desired action on the surface. The power tool may be any power tool able to cause the insert to move in a reciprocating manner and may include a portable power saw such as a saber saw or any other powered jigsaw. The insert is able to at least one of file, sand, grind and chip a substance coating the selected surface.

An insert is described for use with a portable power tool and a method for using a power tool with the insert. The insert includes a working section having at least one active site positioned on a surface thereof and a connection section connected to the working section and including an adapter able to be selectively received by the portable power tool. The active site includes a surface able to at least one chisel, file, rasp, smooth, shape, gouging, chip and remove a substance from a surface of a material.

An adjustable skid plate is described for adjusting a working angle of a power tool and method for using. A main plate includes an adapter for selectively connecting the main plate to the power tool. The main plate further includes a recessed section and first and second guides positioned at opposing sides of the recessed section. A moveable section is pivotally connected to the main plate and received within the recessed section. The moveable section includes a slot extending therethrough providing a conduit for an insert to pass therethrough and first and second legs extending from opposing sides of the moveable member. Each of the first and second legs is received by a respective one of the first and second guides for controlling pivotal movement of the moveable section. A locking mechanism secures the first and second legs within the respective first and second guides thereby retaining the moveable section at a desired angle.

It is an object to provide an insert for use with a powered jigsaw that performs a desired action on a surface for preparing the surface to be at least one of painted and or finished.

Another object is to provide an insert able to at least one of sand, file, grind and chisel a substance on a surface.

Still another object is to provide an insert having a universal connector at an end able to be received by an input port on a portable power saw such as a saber saw.

Yet another object is to provide an insert for receipt by a reciprocating power saw that causes the insert to move rapidly back and forth thereby allowing the insert to accomplish the intended action.

A further object is to provide an insert that increases the capability of a standard portable jigsaw by receiving an insert that is able to perform an action other than cutting a surface. The insert is able to automate the sanding and filing process that is needed in order to prepare a surface to be finished.

### BRIEF DESCRIPTION OF THE DRAWING FIGURES

In order that the invention may be more fully understood, it will now be described, by way of example, with reference to the accompanying drawing in which:

FIG. 1 is a perspective view of the insert and a portable power saw receiving the insert according to invention principles;

FIGS. 2A-2D are front and side views of inserts for receipt by a portable power saw according to invention principles;

FIG. 3 is a perspective view of a portable power saw having an adjustable strike plate according to invention principles;

FIG. 4 is a side view of the adjustable strike plate according to invention principles;

FIG. 5 is a top view of the adjustable section of the adjustable strike plate according to invention principles;

FIG. 6 is an end view of the adjustable section of the strike plate according to invention principles; and

FIG. 7 is a flow diagram describing operation of the insert and the adjustable strike plate according to invention principles.

### DETAILED DESCRIPTION OF THE INVENTION

The following discussion describes in detail one embodiment of the invention. This discussion should not be construed, however, as limiting the invention to that particular embodiment. Practitioners skilled in the art will recognize numerous other embodiments as well.

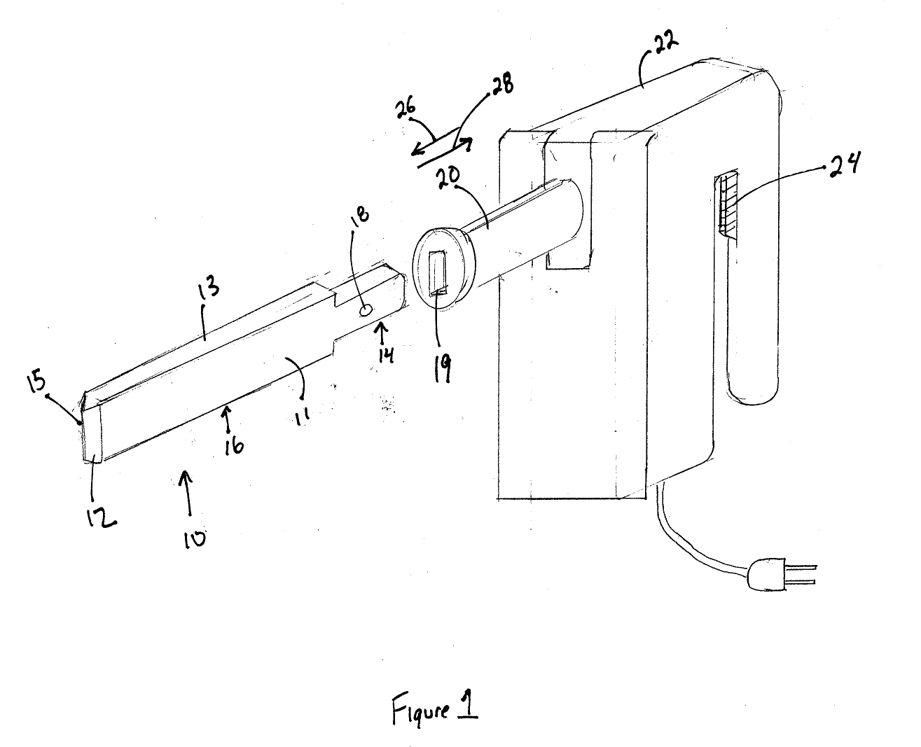

Turning now to the drawings, in which similar reference characters denote similar elements throughout the several views, FIGS. 1 through 7 illustrate an insert for receipt by a power tool which is indicated generally by the reference numeral 10 and an adjustable skid plate for adjusting an angle at which the power tool contacts a surface which is indicated generally by reference numeral 30.

The insert is formed as a blade substantially similar in size and shape to a standard blade for use with a portable powered jigsaw such as a saber saw. However, the insert of the present claimed invention, generally referred to hereinafter with reference numeral 10, includes an outer surface similar to one of but not limited to a wood rasp, a metal file, a wood chisel and a metal chisel. The insert 10, as will be discussed with respect to FIG. 1, is selectively received by the portable power saw and adds functionality to the saw that was heretofore unavailable. Conventional portable power saws are only able to receive blades that are intended to cut through different surfaces. Using the insert 10 of the present invention provides a user the ability to at least one of shape, sand, smooth and grind metal and/or wood as well as to remove paint or rust thereby preparing a surface for painting or staining.

The user is able to use the portable power saw to at least one of file, rasp, chip, chisel, strip and smooth a surface in less time than conventional methods. Many surfaces need to be treated by handing using a handheld rasp, file or chisel because of the difficulty encountered in reaching particular areas using conventional power sanding or smoothing tools such as a belt sander. Therefore, craftsmen were required to expend much time and energy to accomplish the desired task. The insert 10 remedies this by providing an apparatus for use with an automated tool for automating the process of sanding, grinding, chipping, shaping an area that is difficult to access with other automated tools. Specifically, the insert 10 is able to reach into a plurality of cracks and crevices that are commonly associated with metal and wood-based structures. Therefore, the automated filing, sanding or shaping performed using the insert would save time and energy otherwise expended when the same action is performed by hand.

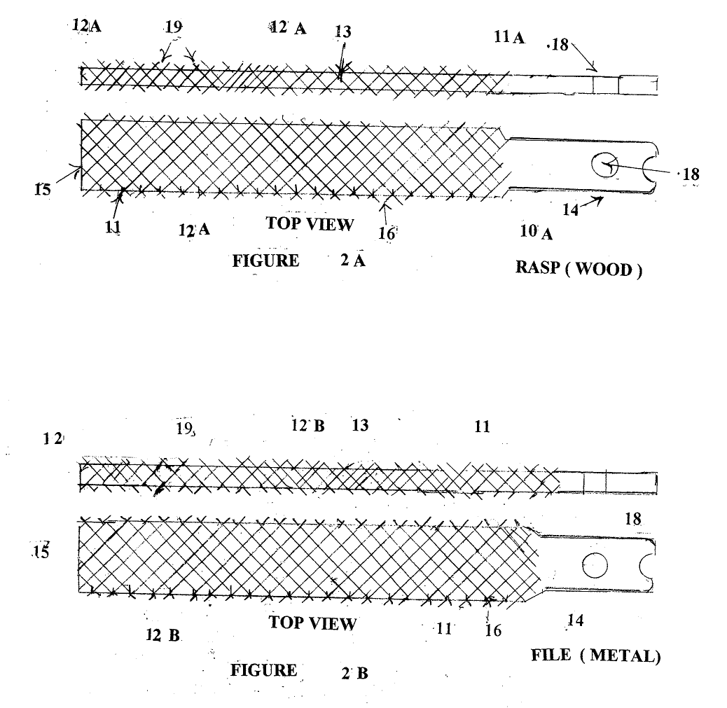

A perspective view of the insert 10 being received by a portable power saw 22 is shown in FIG. 1. The insert 10 as shown herein is a cold chisel intended for chiseling a metal surface to remove a substance, such as paint, coating the surface. As described above, conventionally manual use of a hammer and chisel would be required in order to remove the paint from a surface. The insert 10, in conjunction with the conventional operation of a portable power saw 22, automates the removal process. The portable power saw 22 as shown herein is a saber saw and is merely described for purposes of example. The insert 10 may be used with any portable power tool that causes an insert received thereby to move in a reciprocating manner. Additionally, the insert 10 being formed as a cold chisel is also an exemplary embodiment and other embodiments able to perform different actions will be described hereinafter with specific reference to FIGS. 2A-2D.

The insert 10 is formed as a single attachment and includes a main body 16 and a connector 14. The main body 16 includes a planar side 11 and side edges 13. A tip 15 of the main body 16 is positioned on an end opposite the connector 14. The insert further includes an active site 12. The active site 12 includes a surface able to accomplish a desired action on a selected surface. As shown in FIG. 1, the insert is a cold chisel for chipping and/or chiseling a metal surface. Therefore, the active site 12 is a chisel point having an apex at an edge of the tip 15 of the main body 16. The active site 12 is shown herein at the tip 15 of the main body 16 for purpose of example only and the position of the active site 12 on the main body 16 depends on the function to be performed by the active site 12. Additional active sites 12 will be discussed hereinafter with reference to FIGS. 2A-2D. Alternatively, the active site 12 may be positioned on any or all of the planar sides 11 or the side edges 13 and the tip 15 of the main body.

The connector 14 includes an aperture 18 extending laterally through the connector 14 of the insert 10. The connector 14 is selectively received by a slot 19 of a reciprocating member 20 of the portable power tool 22. Upon receipt within the slot 19, a locking mechanism (not shown) selectively locks the insert 10 therein. The locking mechanism extends through the aperture 18 and releasably secures the insert 10 within the reciprocating member 20. The portable power tool 22 further includes an activation switch 24 that is selectively activatable by a user. Upon activation of the switch 24, the reciprocating member 20 and the insert 10 secured therein are caused to move in a first direction identified by the arrow labeled by reference numeral 26 and then, in a quick succession, in a second opposite direction indicated by the arrow labeled with reference numeral 28. This quick and repeated motion gives rise to the reciprocating action of the tool 22.

The reciprocating action allows the active site 12 of the insert to rapidly contact the selected surface and perform a desired action when the tool 22 is properly position by the user. As shown in this embodiment, the desired action is to chip and/or chisel a substance from the surface with which the active site 12 is engaged.

The insert 10 may be any of a wood rasp, a metal file, a wood chisel and a metal chisel. Each respective insert 10 is discussed below in FIGS. 2A-2D.

FIG. 2A shows an insert formed as a wood rasp, denoted hereinafter by the reference numeral 10a. The insert includes the main body 16 and the connector 14. The main body 16 includes the planar sides 11 and the side edges 13. Each of the planar sides 11 and side edges 13 includes an active site 12. The active site 12 on the wood rasp insert 10a includes a plurality of raised teeth 19 wherein the teeth 19 are spaced at equal predetermined intervals from one another and may extend upward from each of the planar sides 11 and side edges 13 at a predetermined height. The height of each of the plurality of teeth is sufficient to at least one of shape wood, shape plastic, remove rust and remove paint. The side view of the wood rasp insert 10a shows the insert 10a having a first planar side 11a and a second planar side 11b. The active site 12a may be positioned on either or both of the planar sides 11a and 11b and either or both side edges 13. For exemplary purposes, the active site 12a is positioned on the first planar side 11a and the plurality of teeth 19 extend upward from the first planar side 11a.

FIG. 2B illustrates an insert formed as a metal file, denoted hereinafter by the reference numeral 10b. The metal file 10b is substantially similar to wood rasp insert described hereinabove with specific reference to FIG. 2A. However, the plurality of teeth 19 on active site 12b of the metal file insert 10b may range is size and classification from fine to coarse which is able to at least one of smooth and shape metal surfaces as well as remove paint and rust from metal surfaces. A primary difference between the teeth 19 on the wood rasp active site 12a and the teeth 19 on the metal file active site 12b is the height to which the teeth extend from at least one of the planar sides 11 and side edges 13. The teeth extending upward from the metal file active site 12b extend to a height less than a height of the teeth extending upward from the wood rasp active site 12a. Additionally, similar to the wood rasp insert 10a, the side view of the metal file insert 10b shows the metal file insert 10b having a first planar side 11a and a second planar side 11b. The active site 12b may be positioned on either or both of the planar sides 11a and 11b and either or both side edges 13. For exemplary purposes, the active site 12b is positioned on the first planar side 11a and the plurality of teeth 19 extend upward from the first planar side 11a.

FIG. 2C is a wood chisel insert denoted by reference numeral 10c. The wood chisel insert 10c is equivalent in shape and structure to both the wood rasp insert 10a and the metal file insert 10b. However, unlike the rasp insert 10a and file insert 10b, the wood chisel insert 10c includes an active site 12c at a tip 15 of the main body 16. The active site 12c of the wood chisel insert 10c includes a beveled cutting edge at the tip 15 thereof. Additionally, the wood chisel insert 10c is discussed above with respect to FIG. 1. The beveled cutting edge on the active site 12c allows the wood chisel insert 10c to be used for at least one of shaping wood, gouging wood, and removing wood.

FIG. 2D depicts a cold (metal) chisel insert denoted by reference numeral 10d. The cold chisel insert 10d, similar to the wood chisel insert 10c, includes an active site 12d positioned at a tip 15 of the main body 16 of the insert. The active site 12d on the cold chisel has a cutting edge that is centered and beveled on each side adjacent the tip 15. The cold chisel 10d allows an operator of the power tool having the cold chisel insert 10d therein to chip and remove a substance such as paint from a metal surface thereby preparing the surface to be refinished.

As discussed above with respect to FIG. 1, an operator of a portable power tool able to receive any of the inserts (10a, 10b, 10c, 10d) described above in FIGS. 2A-2D is able to perform a plurality of actions on a plurality of different types of surfaces in order to prepare the surface to be refinished or painted. The power tool with any of the inserts 10 allows for rapid and automated filing, smoothing, gouging, chiseling or chipping of a surface thereby eliminating the work that would normally be done by hand. The inserts expand the functionality of the portable power tool thereby making the tool more versatile and reducing an amount of additional handheld tools to be transported to a job site.

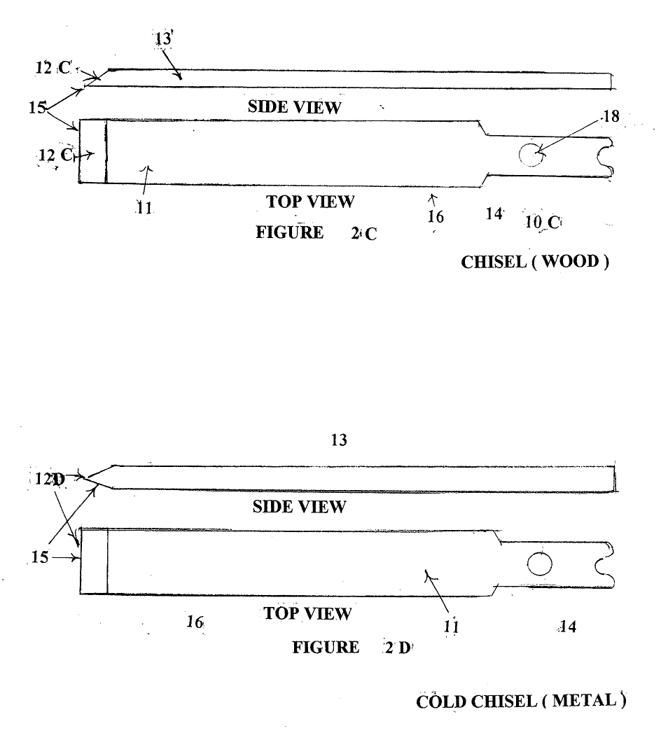

The invention principles also include an adjustable strike plate 30 discussed hereinafter with reference to FIGS. 3-6 for use in changing an angle of impact of the insert 10 and thus changing a depth at which the insert is able to contact the surface. Specifically, the depth of stroke must be carefully maintained or the insert 10 may snap off if the insert 10 strikes the item and/or surface at either too acute or too obtuse of an angle. By controlling the depth of the stroke, the operator will avoid this problem and be able to more effectively work the surface of the object being treated.

The adjustable strike plate 30 is similarly useful during the intended use of the portable power saw. Specifically, the adjustable strike plate allows a user to selectively control a depth at which a saw blade cuts into a surface. Conventional portable power saws, such as saber saws, have a fixed cutting depth of substantially 3¼ inches. Under most conditions this is not a problem. However, there are times when controlling a depth of the cut is needed. For example, the adjustable strike plate is useful when the operator is cutting a material where wires or pipes are behind the material being cut and a danger of cutting into the wires or pipes exists. Conventionally, an operator would cut the material with a handsaw which is a slow and laborious process and still does not guarantee that the operator will avoid cutting into the pipe or wires. By selectively controlling the depth at which the blade is allowed to cut into the surface, the user is assured of not cutting through objects behind the surface such as pipes and/or electrical wires unintentionally.

Conventionally, the skid plate allows a user to rest the weight of the portable saw on the material being cut thereby. This provides for a more precise cutting action but only provides a standard, non-adjustable cutting depth. Additionally, when using any of the respective inserts 10, a conventional skid plate allows a user to maintain similar control when filing, sanding, grinding and chiseling. It is therefore desirable to maintain the precision during cutting, sanding, grinding and chiseling while being able to change the depth at which a blade cuts the material and/or change the surface area with which the insert is allowed to contact the surface during any of sanding, grinding, shaping and chiseling, gouging and chipping.

FIG. 3 shows a portable power saw having an adjustable skid plate 30 attached thereto. The adjustable skid plate 30 includes a plate 29 and a moveable section 32 selectively connected to the tool or power saw. The moveable section 32 is connected to the plate 29 via a hinge 31 at a predetermined position from a leading edge of the plate 29. The hinge allows for pivoting of the moveable section 32 to extend at a desired angle. The moveable section 32 may be hinged at point substantially a third of the distance from a leading edge 42 of the adjustable skid plate 30. The moveable section 32 is pivotable about the hinge 31 thereby allowing an angle at which the moveable section 32 extends from the plate 29 to be selectively increased or decreased. Alternatively, the adjustable skid plate 30 may be formed as the plate 29 which may be hingedly connected at a rear edge 44 thereof thereby allowing the angle at which the plate 29 extends from the tool 22 to be selectively increased or decreased and thereby change the depth at which an insert 10 or blade contacts or cuts the material. In this alternate embodiment, the angled plate 29 provides increase support for the saw during cutting a material or finishing a surface.

The moveable section 32 may be formed as a U-shaped member having a slot 33 positioned therebetween. The slot 33 is aligned with the slot 19 of the reciprocating member 20 that receives either the insert 10 or a conventional blade therein. The insert 10 or conventional blade extend from the reciprocating member and through the slot 33 of the moveable section 32. The length of the portion of the blade or insert extending beyond the moveable section 32 is hereinafter referred to as either cutting depth in reference to a blade and action depth in reference to an insert 10. The base of the U-shaped member is connected via the hinge 31 to the plate 29 thereby allowing the moveable section 32 to pivot about the hinge 31. Alternatively, the moveable section 32 may be formed from two individual legs with the slot 33 positioned therebetween wherein each leg is pivotable together and connected via the hinge 31 to the plate 29. In this embodiment, the legs would pivot together. The movement of the moveable section 32 is controlled by corresponding curvilinear legs 34 extending from a first side of the moveable section 32 and positioned on opposing edges thereof. The legs 34 each include a movement slot 38 extending along a length thereof. Additionally, the legs include a plurality of indicia indicating the cutting depth or action depth at different positions along the length of the legs 34.

The plate 29 includes first and second guides 36 connected thereto and extending upward in a direction towards the saw 22. Each of the guides 36 is positioned adjacent a respective edge of the plate between which the moveable section 32 is positioned and receives a respective leg 34 therethrough. Each guide 36 includes a channel 37 extending therethrough for selectively receiving a respective one of the legs 34 therein. The moveable section 32 is pivotable about the hinge 31. The pivoting of the moveable section 32 causes the legs 34 to move through the channel 37. As the legs 34 move through the channel 37 of the guide 36, the angle between the moveable section 32 and the plate 29 is changed. Thus, the cutting depth or action depth of either the blade or insert 10 may be selectively increased or decreased depending upon the position of the legs 34 within channel 37 of the guides 36 and the angle created between the moveable section 32 and the plate 29.

The guide 36 further includes a fastening device 40 positioned on an outer surface thereof for locking the legs 34 within the respective guides 36 and the moveable section 32 into a desired position. The fastening device 40 selectively fastens the moveable section 32 by securing the legs 34 within the channel 37 of the guide 36 so that the moveable section 32 extends at a desired angle from the plate 29. Upon fastening the moveable section 32 in place, the angle created between the moveable section 32 and the plate 29 is locked and the desired cutting depth or action depth is maintained. The fastening device 40 may be a thumbscrew wherein a post of the screw passes through the guide 36 and further through the movement slot 38 of the respective leg 34. A screw mechanism selectively rotates the post and secures the leg 34 within the guide 36. The use of thumbscrews is described for purposes of example only and any fastening device able to fasten the legs 34 within the channel 37 of the guide 36 may be used. Upon locking the moveable section 32 at the desired angle, the moveable section provides a support surface able to support for the weight of the portable power saw 22 or tool when cutting a material using a blade and at least one of grinding, shaping, chiseling, smoothing and gouging a surface using an insert 10.

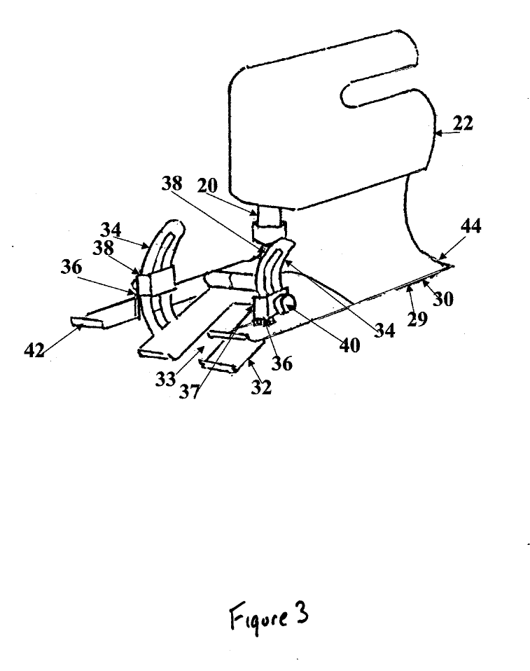

FIG. 4 is a side view of the adjustable skid plate 30. Shown herein, the moveable section 32 is pivoted about the hinge 31 causing the legs 34 to move through the channel 37 of the respective guides 36. An insert 10 is shown extending through the slot 33, shown in FIG. 3, of the moveable section 32. The insert 10 as shown herein is at least one of a wood rasp or metal file but is shown for purposes of example only and may be any of the inserts discussed above with respect to FIGS. 2A-2D.

When the moveable section 32 is aligned with the plate 29 and locked in place via the fastening device 40, a first standard action length of the insert 10 extends beyond the plate 29 and moveable section 32. The standard length is indicated herein by reference numeral 46.

However, as shown in FIG. 4, when a user desires to change the action depth of the insert 10, the fastening device 40 is loosened thereby allowing the moveable section 32 to pivot about the hinge 31 in a direction away from the plate 29 indicated by the arrow labeled with reference numeral 44 causing the legs 34 to move through the channel 37 of the respective guide 36. Markings 50 on the arced sides of the legs 34 indicate a depth that the cutting blade will make or indicate the amount of the insert that will be used to perform the desired action (i.e. shaping, smoothing, chiseling) if the legs 34 are locked into position at that point. When the moveable section 32 extends at the desired angle from the plate 29, the fastening device 40 is tightened and fastens the legs 34 within the guides 36.

Upon fastening the moveable section 32 at a desired angle, the action length of the insert 10 is decreased as compared to the standard action length 46. The decreased action length of the insert is indicated herein by reference numeral 48. This decrease in length changes the area of the active site 12 of the insert 10 extending beyond the moveable section for acting on a surface. Any additional adjustments as required by the nature of the job being performed may be made in a similar manner as described above.

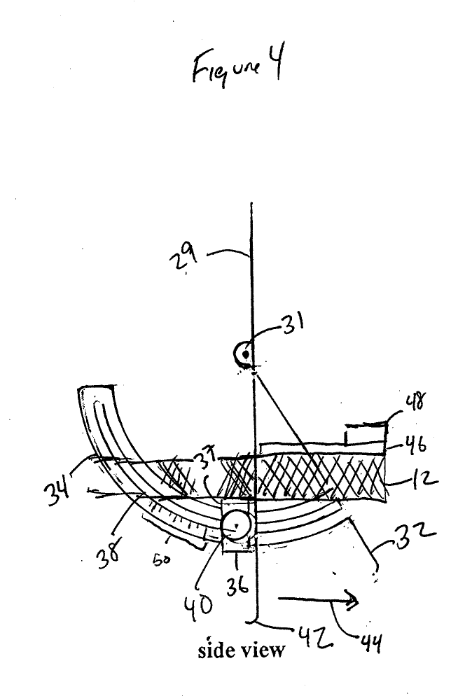

FIG. 5 is a top view of the adjustable skid plate 30. The plate 29 includes a cut-out 35 adjacent the leading edge 42 thereof. The moveable section 32 is hingedly attached to the plate 29 within the cut-out 35. The moveable section 32 includes the legs 34 having movement slots 38 as described hereinabove with respect to FIGS. 3 and 4 extending perpendicular to the moveable section 32 and towards the plate 29. Each of the legs 34 are received within the channel 37 of a corresponding guide 36. The guide 36 is connected to the plate at an edge adjacent the cut-out 35 and partially extends into the cutout 35. Each guide 36 is aligned to receive a respective leg 34 of the moveable section 32. As, the moveable section is pivoted about the hinge 31 and the legs 34 are caused to move through the channel 37 thereby allowing a user to change the desired cutting depth of a saw blade or the action depth of an insert 10 as described hereinabove.

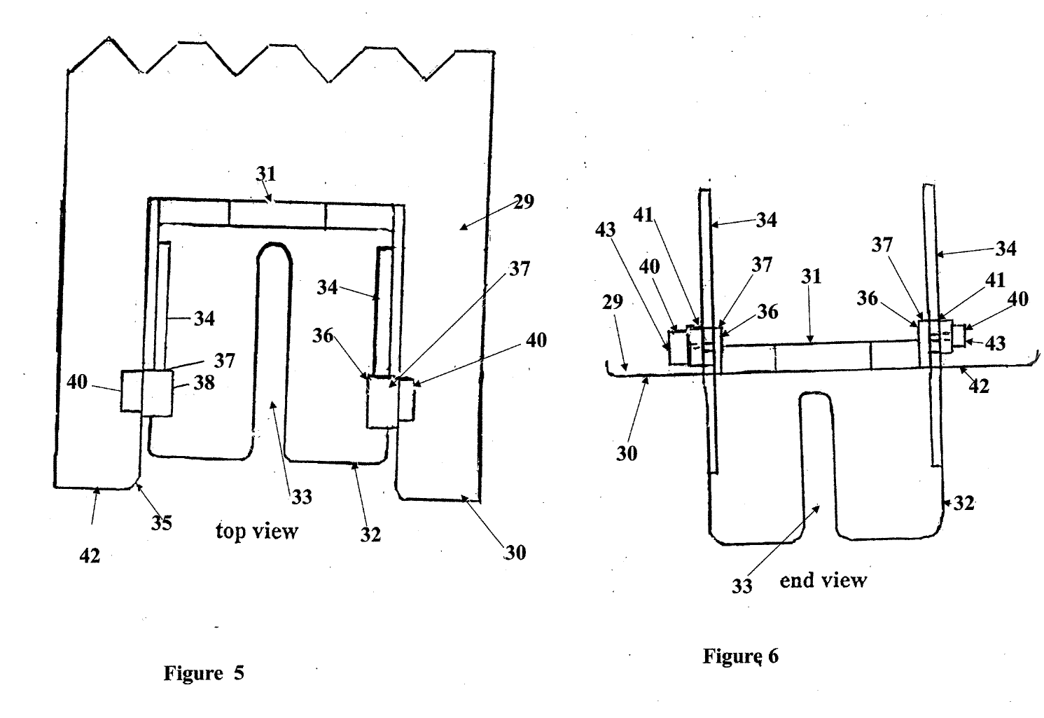

FIG. 6 is a front cross-section view of the leading edge 42 of the adjustable skid plate 32. Shown herein is the moveable section 32 pivoted about the hinge 31. The legs 34 are selectively lockable using the fastening devices 40 on each guide member 36 thereby securing the legs 34 within the channel 37 of the guide 36. The fastening mechanism 40 shown herein is a screw mechanism including a screw head 43 and a post 41 connected to and extending outward from a side of the screw head 43. The post 41 extends through the channel 37 of the guide member and is received through the movement slot 38 of the respective leg 34. The screw head 43 is selectively rotatable causing the leg 34 to be releaseably locked in position within the channel 37 of the guide thereby selectively setting the cutting depth or action depth according to user specifications.

The adjustable skid plate 30 is discussed above for use with a portable power saw. This includes at least one of a saber saw, jigsaw, circular saw or any other reciprocating saw and the principles discussed above may be applied according to the type of saw. For example, should the skid plate 30 be used with a circular saw, the moveable section 32 would be hingedly connected to the plate 29 at the rear end such that the entire skid plate 30 is caused to pivot about the hinge to change the cutting depth of the saw blade.

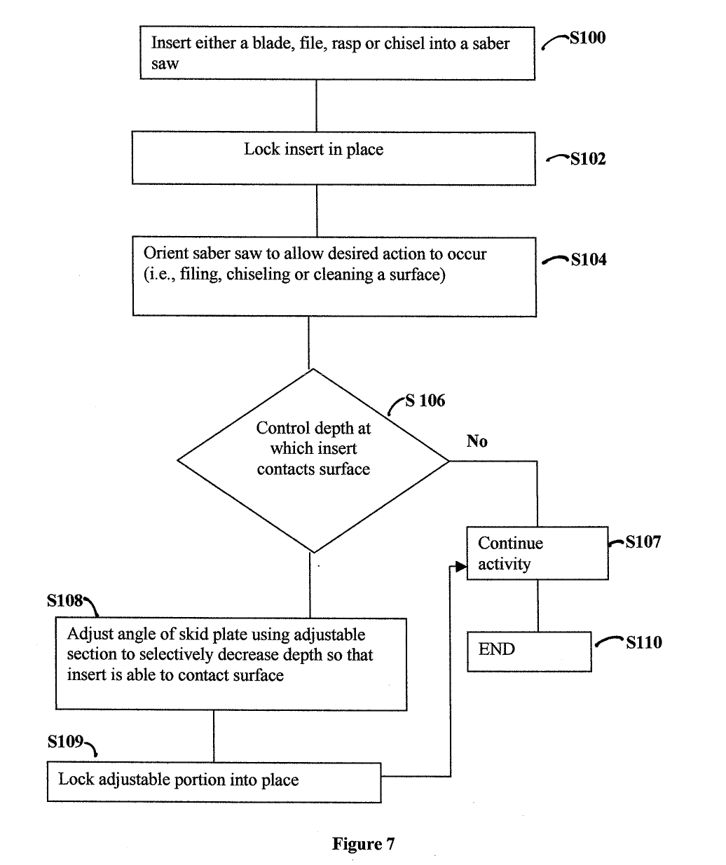

FIG. 7 is a flow diagram detailing the operation of the portable power tool with the insert and adjustable skid plate thereof. In step S100, a user selectively inserts at least one of a blade, file, rasp or chisel into a portable power tool such as a saber saw. The insert or blade must then be locked into place according to known practices in step S102. Depending on the nature of the action being performed, the saber saw is oriented to allow the desired action to be performed in step S104. Specifically, the desired action may include any of filing, sanding, shaping, chiseling, gouging, chipping or cutting into a selected surface. The user, in step S106, must determine if the depth at which the insert contacts the surface or cuts into the surface should be changed. If the user does not desire to change the depth, then the user continues the activity in step S107 and completes the activity in step S110.

If the user desires to change the depth, step S108 states that the moveable member of the skid plate is selectively pivoted in a manner discussed above in FIGS. 3-6 to change the angle at which the moveable section extends from the plate. Augmenting the angle in the described manner selectively increases or decreases either a depth at which the blade is able to cut into the material or decreases an area of the active site used to contact the surface or further orients the insert at a predetermined angle to ensure the activity can be completed without damaging the at least one of the insert and the power tool. Once the desired angle is selected in step S108, the moveable section is locked into place in step S109 and the user returns to step S107 to continue the activity until completed in step S110.

It will be understood that each of the elements described above, or two or more together may also find a useful application in other types of devices differing from the type described above.

While certain novel features have been shown and described and are pointed out in the annexed claims, it is not intended to be limited to the details above, since it will be understood that various omissions, modifications, substitutions and changes in the forms and details of the device illustrated and in its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed is:

1. An insert for use with a portable power tool, the insert comprising:
a working section having at least one active site positioned on a surface thereof; and
a connection section connected to said working section including an adapter able to be selectively received by the portable power tool, wherein said active site includes a surface able to at least one chisel, file, rasp, smooth, shape, gouging, chip and remove a substance from a surface of a material.

2. The insert as recited in claim 1, wherein the power tool imparts a reciprocating motion to the insert.

3. The insert as recited in claim 1, wherein said at least one active site is positioned on an end of said working section opposite said connection section.

4. The insert as recited in claim 3, wherein said active site is at least one of a beveled edge for performing at least one of chiseling, gouging, chipping and removing a substance from a surface; a pointed tip tapered from each side of the working section for performing at least one of chiseling, gouging, chipping and removing a substance from a surface.

5. The insert as recited in claim 1, wherein said at least one active site is positioned along a length of at least one side of said working section.

6. The insert as recited in claim 5, wherein said active site comprises at least one of a plurality of teeth extending from said surface of said working section; and a plurality of ridges etched into said surface of said working section.

7. The insert as recited in claim 1, further comprising an adjustable skid plate selectively connected to the power tool for adjusting an angle of impact of said insert on the surface.

8. The insert as recited in claim 1, wherein said adjustable skid plate comprises:
a main plate including
an adapter for selectively connecting said main plate to the power tool;
a recessed section; and
first and second guides positioned at opposing sides of the recessed section;
a moveable section pivotally connected to the main plate and received within the recessed section, the moveable section including
a slot extending therethough providing a conduit for an insert to pass therethough; and
first and second legs extending from opposing sides of said moveable member, each of said first and second legs being received by a respective one of said first and second guides for controlling pivotal movement of said moveable section; and
a locking mechanism for securing the first and second legs within the respective first and second guides thereby retaining the moveable section at a desired angle.

9. A method for using an insert with a portable power tool comprising the activities of:
inserting a connecting section of the insert into an adapter of the power tool;
placing an active site of the insert against a surface of the material to be worked on;
operating the power tool;
imparting a reciprocating motion to the insert; and
performing at least one of chiseling, filing, rasping, smoothing, shaping, gouging, chipping and removing the substance from the contacted surface.

10. The method as recited in claim 9, further comprising the activities of
connecting an adjustable skid plate to the power tool;
selectively adjusting an angle of the adjustable skid plate;
positioning the adjustable skid plate against the work surface thereby adjusting an angle at which the power tool extends and the insert impacts the surface.

11. The method as recited in claim 9, wherein the insert comprises:
a working section having at least one active site positioned on a surface thereof; and
a connection section connected to said working section including an adapter able to be selectively received by the portable power tool, wherein said active site includes a surface able to at least one chisel, file, rasp, smooth, shape, gouging, chip and remove a substance from a surface of a material;

12. An adjustable skid plate for adjusting a working angle of a power tool comprising:
a main plate including
an adapter for selectively connecting said main plate to the power tool;
a recessed section; and
first and second guides positioned at opposing sides of the recessed section;
a moveable section pivotally connected to the main plate and received within the recessed section, the moveable section including
a slot extending therethrough providing a conduit for an insert to pass therethrough; and
first and second legs extending from opposing sides of said moveable member, each of said first and second legs being received by a respective one of said first and second guides for controlling pivotal movement of said moveable section; and
a locking mechanism for securing the first and second legs within the respective first and second guides thereby retaining the moveable section at a desired angle.

13. The adjustable skid plate as recited in claim 14, wherein said locking mechanism is a screw for rotatably securing said first and second legs with said respective first and second guides.

14. The adjust able skid plate as recited in claim 15, wherein said first and second legs have respective first and second slots extending along a length thereof, said first and second slots able to receive said screw of said locking mechanism therethrough.

15. The adjustable skid plate as recited in claim 14, wherein said first and second legs further comprise indicia extending along a surface thereof identifying at least one of (a) an angle at which the moving section extends from the plate; (b) a depth at which an insert will impact a working surface when the power tool is positioned adjacent the working surface; and (c) a length of the insert extending beyond said moveable section.

16. A method for adjusting a working angle of a power tool comprising the activities:
connecting an adjustable skid plate to the power tool;
selectively pivoting a moveable section of the adjustable skid plate to extend at a desired angle to a main plate of the adjustable skid plate;
moving first and second legs extending from the movable section within respective first and second guides connected to the main plate;
locking the first and second legs within the respective first and second guides via a locking mechanism thereby retaining the moveable section at a desired angle; and
placing the movable section against a surface on which the power tool is to work causing the power toll to be positioned at an angle defined by the movable section to the surface.

17. The method as recited in claim 16, wherein said activity of locking further comprises rotatably securing the first and second legs within the respective first and second guides using a screw mechanism.

18. The method as recited in claim 16, wherein said activity of moving the first and second legs further includes the activity of examining indicia extending along a surface of the first and second legs and identifying indicia indicating at least one of a desired (a) angle at which the moving section extends from the plate; (b) depth at which an insert will impact a working surface when the power tool is positioned adjacent the working surface; and (c) length of the insert extending beyond said moveable section.

19. The method as recited in claim 16, wherein the adjustable skid plate comprises
a main plate including
an adapter for selectively connecting said main plate to the power tool;
a recessed section; and
first and second guides positioned at opposing sides of the recessed section;
a moveable section pivotally connected to the main plate and received within the recessed section, the moveable section including
a slot extending therethrough providing a conduit for an insert to pass therethrough; and
first and second legs extending from opposing sides of said moveable member, each of said first and second legs being received by a respective one of said first and second guides for controlling pivotal movement of said moveable section; and
a locking mechanism for securing the first and second legs within the respective first and second guides thereby retaining the moveable section at a desired angle.
